(19) United States
(12) Patent Application Publication
(10) Pub. No.: US 2011/0066703 A1
(43) Pub. Date: Mar. 17, 2011

(54) Methods and systems for delivering media to client device

(75) Inventors: Scott Aaron Kaplan, Half Moon Bay, CA (US); Michael John Page, Allambie (AU)

(73) Assignee: Creative Ad Technology Proprietary Limited, Sydney (AU)

(21) Appl. No.: 12/801,084

(22) Filed: May 20, 2010

(30) Foreign Application Priority Data
May 20, 2009 (AU) 2009902277

(51) Int. Cl. G06F 15/16

(52) U.S. Cl. 709/219; 709/231

(57) ABSTRACT

Methods (300), proxy servers (110, 410), systems, apparatus and computer program products for delivering time-based media to a client device in a communications network (150) are disclosed. In certain embodiments, a proxy server (110, 410) receives (300) a request for a media file using transfer protocol such as Hypertext Transfer Protocol (HTTP) from a wireless client device (120, 420). The proxy server (110, 410) obtains (312) headers for at least two media files using HTTP provided by one or more media servers (140, 170, 440, 442). The proxy server (110, 410) transmits (314) to the wireless client device (120, 420) using HTTP a header of a virtual media file derived from the headers of the at least two media files. The proxy server (110, 410) receives (316) from the wireless client device (120, 420) using HTTP a request for the virtual media file in response to the header of the virtual media file. The proxy server (110, 410) transmits (318) to the wireless client device (120, 420) using HTTP the virtual media file comprising the obtained media files.

### CROSS-REFERENCE TO RELATED APPLICATION

The present application claims the benefit of priority from Australian Provisional Patent Application No. 2009902277, filed May 20, 2009, entitled “Methods and Systems for Streaming Media to Client Device.” The foregoing related application, in its entirety, is hereby incorporated by reference.

### TECHNICAL FIELD

The present disclosure in some aspects relates generally to streaming media to a client device and more particularly to streaming audio and/or video without transcoding to a client device. The present disclosure in some aspects relates generally to delivering time-based media to a client device in a network.

### BACKGROUND

Delivery and playback of multiple media files for wireless devices can create a great expense for media companies looking to create a high-quality user experience. Many solutions currently used within the industry involve transcoding multiple media files into one file that is delivered to the end user. This creates a scalability issue from a business perspective, as more users access content and/or advertisements, the larger investment is required in transcoding equipment.

A need exists for a more scalable alternative to delivering multiple media files, in real time, or substantially real time, such as ads and content, whilst maintaining both scalability and user experience. A need also exists for being able to insert ads and content dynamically on the fly and deliver this information to the user.

### SUMMARY

In certain embodiments, methods of delivering time-based media to a client device in a network, said method comprising the steps of: receiving at a proxy appliance via said network a request for a media file using a transfer protocol from a client device; obtaining by said proxy appliance data for at least two media files using said transfer protocol; transmitting from said proxy appliance to said client device via said network using said transfer protocol data of a virtual media file derived from said data of said at least two media files; receiving by said proxy appliance from said client device using transfer protocol a request for said virtual media file in response to said data of said virtual media file; and transmitting from said proxy appliance to said client device using transfer protocol said virtual media file. In certain aspects, the client device may be a wireless client device. In certain aspects, the proxy appliance may be a proxy server. In certain aspects, the network may be a wireless communication network. In certain aspects the transfer protocol may be HTTP, UDP, RTP, RTCP, RTSP, FTP, MMS, HTTPS, other transfer protocols, or combinations thereof. In certain aspects, the wireless client device may support progressive downloading. In certain aspects, the wireless client device may support streaming, progressive download, download or combinations thereof. In certain aspects, the data may be from the header. The data is typically located in the media file header but could otherwise be located on another system or be derived by some intelligent process. In certain aspects, these methods can deliver the virtual media file, in real time, or substantially real time. In certain aspects, these methods are able to insert ads and/or content dynamically on the fly and deliver this information. In certain aspects, these methods can deliver the virtual media file, or virtual media files to a plurality of users and are able to insert ads and/or content dynamically on the fly and deliver this information in real time, or substantially real time.

In certain embodiments, methods of delivering time-based media to a client device in a network, said method comprising the steps of:

obtaining by a proxy appliance data for at least two media files using a transfer protocol provided by one or more media servers and generating a virtual media file;

receiving by said proxy appliance from said client device using transfer protocol a request for said virtual media file; and transmitting from said proxy appliance to said client device using transfer protocol said virtual media file. In certain aspects the generated virtual media file may be stored and transmitted at a later point in time.

In certain aspects, the client device may be a wireless client device. In certain aspects, the proxy appliance may be a proxy server. In certain aspects, the network may be a wireless communication network.

In certain aspects, these methods can deliver the virtual media file, in real time, or substantially real time. In certain aspects, these methods are able to insert ads and/or content dynamically on the fly and deliver this information. In certain aspects, these methods can deliver the virtual media file, or virtual media files to a plurality of users and are able to insert ads and/or content dynamically on the fly and deliver this information in real time, or substantially real time.

As used herein, the present disclosure contemplates that where a particular paragraph references to a specific transfer or transport protocol other transfer or transport protocols could be interchanged singularly or in combination.

In accordance with certain embodiments, there is provided methods of streaming media to a wireless client device in a wireless communications network. A request for a media file using Hypertext Transfer Protocol (HTTP) from a wireless client device that supports progressive downloading is received at a proxy server via the wireless communications network. The proxy server obtains headers for at least two media files using HTTP provided by one or more media servers different to the proxy server. The proxy server transmits to the wireless client device via the wireless communications network using HTTP a header of a virtual media file derived from the headers of the at least two media files. The proxy server receives from the wireless client device using HTTP a request for the virtual media file in response to the header of the virtual media file. The proxy server transmits to the wireless client device using HTTP the virtual media file comprising the obtained media files.

In certain embodiments, a virtual media is a method of connecting a remote media source (i.e. CD-ROM drive, hard disk drive, floppy disk drive, or virtual implementation of any of them) to a local system, e.g. a wireless client device. The local system then has access to the remote (and possibly virtual) media and can potentially read from and write to that media as if it were physical and local. If the remote media were also virtual then it might be implemented as a file which is served sector by sector over a communications link such as wireless to the local system.

In certain embodiments, the wireless client device supports progressive streaming in the wireless network. In certain embodiments the wireless client device may support other methods of downloading, for example, streaming, download before play. In certain embodiments methods of downloading may be combined.

The one or more media servers may be coupled to the proxy server via another communications network different to the wireless communications network.

The obtained media files may comprise audio files and/or video files and/or other time based media formats. Further, at least one of the obtained media files may comprise an advertisement.

In certain embodiments, the wireless client device is an Apple™ Iphone™.

In certain embodiments, the wireless client device may comprise a cellular telephone, IP enabled device or other network type with a client application adapted for downloading method such as progressive streaming using a transfer protocol such as HTTP.

In certain aspects, these methods can deliver the virtual media file, in real time, or substantially real time. In certain aspects, these methods are able to insert ads and/or content dynamically on the fly and deliver this information. In certain aspects, these methods can deliver the virtual media file, or virtual media files to a plurality of users and are able to insert ads and/or content dynamically on the fly and deliver this information in real time, or substantially real time.

In certain embodiments, there is provided methods of media file delivery to a client device in a communications network wherein said methods comprises the steps of: sourcing by a proxy server using a network control protocols, such as Real Time Streaming Protocol (RTSP), at least two separate media files from one or more media servers (which can include the local host) in response to a client device request to said proxy server for a virtual media file, optionally modifying duration information associated with said sourced media files at said proxy server; and transmitting from said proxy server using said network control protocols such as RTSP said media files as said virtual media file to said client device via said communications network without transcoding or creating a new combined file, said virtual media file comprising said media files.

In accordance with certain embodiments, there is provided methods of streaming media to a client device in a communications network. A streaming proxy server using Real Time Streaming Protocol (RTSP) sources at least two separate media files from one or more media servers different to the streaming proxy server in response to a client device request to the streaming proxy server using RTSP for a virtual media file. Duration information associated with the sourced media files is removed by the streaming proxy server. The streaming proxy server using RTSP streams from the media files as the virtual media file to the client device via the communications network without transcoding or creating a new combined file. The virtual media file comprises the media files.

In certain aspects, these methods can deliver the virtual media file, in real time, or substantially real time. In certain aspects, these methods are able to insert ads and/or content dynamically on the fly and deliver this information. In certain aspects, these methods can deliver the virtual media file, or virtual media files to a plurality of users and are able to insert ads and/or content dynamically on the fly and deliver this information in real time, or substantially real time.

As used in this disclosure the phrase “duration information associated with the source media files is removed” means that the duration information associated with the source media files may be removed, modified, left intact, replaced or combinations thereof. As used in this disclosure a source media file is defined as an actual media file and/or virtual media file. In other words the resulting virtual media file could itself be comprised of other virtual media files and/or actual media files. The aim is to take the existing duration information of the source media files and derive a set of duration information that will permit the virtual media file to play seamlessly the play list.

As used in this disclosure the term “without transcoding” does not mean that no transcoding can be undertaken but rather means that if transcoding is performed that the amount of transcoding does not preclude scalability or delivering the virtual media file (or files) in real time or substantial real time.

As used in this disclosure the term “creating a new combined file” does not preclude the creation of a new media file but rather means that if a new media file is created the creation does not preclude scalability or delivering the virtual media file (or files) in real time or substantial real time.

In certain aspects, the methods may further comprise the steps of: detecting the current network conditions of the client device to which the media files are streamed; and adjusting the bandwidth delivered to the client device for streaming the media files by selecting either a higher or lower bitrate encoded video stream in response to the detected current network conditions.

In certain aspects, the step of controlling data rates using RTSP to the client device to ensure a consistent stream with minimal packet loss or buffering.

In certain aspects, the media files may be sourced from different web servers residing on different networks.

In certain aspects, the sourced media files may comprise audio files and/or video files. Further, at least one of the sourced media files comprises an advertisement.

Various protocols may be used in the disclosed embodiments for transferring data. For example, transport layer protocols such as UDP, application layer protocols such as HTTP which also know as transfer protocols, transport protocols such as RTP and RTCP, network control protocols such RTSP. It is contemplated that where a specific protocol is referenced in a particular embodiment, for example, such as UDP, that it may be possible to us other transport layer protocols or the equivalent protocol in a that particular embodiment.

In certain aspects, the sourcing step may comprise: negotiating by the proxy server using a transfer protocol the request for a virtual media file between the client device and the one or more media servers, wherein the duration information is removed from headers of the media files; setting up at least two Transport Layer Protocols connections for Transfer Protocols between the client device and the proxy server using a Network Control Protocol, such as RTSP and two Transport Layer Protocols, such as UDP connections for Transfer Protocols, such as RTP and RTCP between a first media server and the proxy server using a Network Control Protocol, such as RTSP, the client device being provided two port numbers of the proxy server for the Transport Layer Protocols, such as UDP connections instead of two port numbers of the first media server; and the streaming step delivers (such as via a stream) a first media file from the first media server of the virtual media file to the client device by the proxy server using a Network Control Protocol, such as RTSP using the Transport Layer Protocols, such as UDP connections until the end, or substantially the end, of the first media file is reached.

In certain aspects, the sourcing step may comprise: closing the at least two UDP connections for RTP and RTCP between the first media server and the streaming proxy server using RTSP; setting up at least two UDP connections for RTP and RTCP between a second media server and the streaming proxy server using RTSP, the client device being provided at least two port numbers of the streaming proxy server for the UDP connections instead of at least two port numbers of the second media server; and the streaming step streams a second media file from the second media server of the virtual media file to the client device by the streaming proxy server using RTSP using the UDP connections until the end of the second media file is reached. In certain aspects, the methods may further comprise the step of closing the two UDP connections for RTP and RTCP between the client device and the streaming proxy server using RTSP and the two UDP connections for RTP and RTCP between the second media server and the streaming proxy server using RTSP.

In certain embodiments, the client device may be a (mobile phone or a computing device) coupled by a wireless network to the proxy server using a Network Control Protocol, such as RTSP. The client device may be a computing device coupled by a communications network to the proxy server using a Network Control Protocol, such as RTSP.

In certain aspects, the sourcing step may comprise: negotiating by the proxy server using RTSP the request for a virtual media file between the client device and the one or more media servers, wherein the duration information is removed from headers of the media files; setting up two UDP connections for RTP and RTCP between the client device and the proxy server using RTSP and two UDP connections for RTP and RTCP between a first media server and the proxy server using RTSP, the client device being provided two port numbers of the proxy server for the UDP connections instead of two port numbers of the first media server; and the streaming step streams a first media file from the first media server of the virtual media file to the client device by the proxy server using RTSP using the UDP connections until the end, or substantially the end, of the first media file is reached.

In certain aspects, the sourcing step may comprise: closing the at least two UDP connections for RTP and RTCP between the first media server and the proxy server using RTSP; setting up at least two UDP connections for RTP and RTCP between a second media server and the proxy server using RTSP, the client device being provided at least two port numbers of the proxy server for the UDP connections instead of at least two port numbers of the second media server; and the streaming step streams a second media file from the second media server of the virtual media file to the client device by the proxy server using RTSP using the UDP connections until the end of the second media file is reached. In certain aspects, the methods may further comprise the step of closing the two UDP connections for RTP and RTCP between the client device and the proxy server using RTSP and the two UDP connections for RTP and RTCP between the second media server and the proxy server using RTSP.

In certain embodiments, the client device may be a mobile phone or a computing device coupled by a wireless network to the proxy server using a Network Control Protocol, such as RTSP. The client device may be a computing device coupled by a communications network to the proxy server using a Network Control Protocol, such as RTSP.

In accordance with certain embodiments, there is provided a proxy server for delivering media files, such as via a streaming media method, to a wireless client device in a wireless communications network. The server comprises: a module for receiving at a proxy server via the wireless communications network a request for a media file using an Application Layer protocol, such as Hypertext Transfer Protocol (HTTP) from a wireless client device that supports file downloading, such as progressive streaming; a module for obtaining by the proxy server headers for at least two media files using an Application Layer protocol, such as HTTP provided by one or more media servers (or the local host) different to the proxy server; a module for transmitting from the proxy server to the wireless client device via the wireless communications network using an Application Layer protocol data-source, such as HTTP a header of a virtual media file derived from the headers of the at least two media files; a module for receiving by the proxy server from the wireless client device using HTTP a request for the virtual media file in response to the header of the virtual media file; and a module for transmitting from the proxy server to the wireless client device using HTTP the virtual media file comprising the obtained media files.

In accordance certain embodiments, there is provided a proxy server for streaming media to a wireless client device in a wireless communications network. The server comprises: a memory for storing data and a computer program; and a processor coupled to the memory for executing the computer program. The computer program comprises a computer program code module for receiving at a proxy server via the wireless communications network a request for a media file using Hypertext Transfer Protocol (HTTP) from a wireless client device that supports progressive streaming; a computer program code module for obtaining by the proxy server headers for at least two media files using HTTP provided by one or more media servers different to the proxy server; a computer program code module for transmitting from the proxy server to the wireless client device via the wireless communications network using HTTP a header of a virtual media file derived from the headers of the at least two media files; a computer program code module for receiving by the proxy server from the wireless client device using HTTP a request for the virtual media file in response to the header of the virtual media file; and a computer program code module for transmitting from the proxy server to the wireless client device using HTTP the virtual media file comprising the obtained media files.

In accordance with certain embodiments, there is provided a proxy server for streaming media to a client device in a communications network. The server comprises: a module for sourcing by a proxy server using Real Time Streaming Protocol (RTSP) at least two separate media files from one or more media servers different to the proxy server in response to a client device request to the proxy server using RTSP for a virtual media file, duration information associated with the sourced media files being removed by the proxy server; and a module for streaming from the proxy server using RTSP the media files as the virtual media file to the client device via the communications network without transcoding or creating a new combined file, the virtual media file comprising the media files.

In accordance with certain embodiments, there is provided a proxy server for streaming media to a client device in a communications network. The server comprises: a memory for storing data and a computer program; and a processor coupled to, or in communication with, the memory for executing the computer program. The computer program comprises a computer program code module for sourcing by a streaming proxy server using Real Time Streaming Protocol (RTSP) at least two separate media files from one or more media servers different to the streaming proxy server in response to a client device request to the streaming proxy server using RTSP for a virtual media file, duration information associated with the sourced media files being removed by the streaming proxy server; and a computer program code module for streaming from the streaming proxy server using RTSP the media files as the virtual media file to the client device via the communications network without transcoding or creating a new combined file, the virtual media file comprising the media files.

In certain aspects, the proxy server can deliver and/or stream the virtual media file, in real time, or substantially real time. In certain aspects, the proxy server is able to insert ads and/or content dynamically on the fly and deliver and/or stream this information. In certain aspects, the proxy server can deliver and/or stream the virtual media file, or virtual media files to a plurality of users and are able to insert ads and/or content dynamically on the fly and deliver and/or stream this information in real time, or substantially real time.

In certain embodiments, there is provided a computer program product comprising a computer readable medium having recorded thereon a computer program for streaming media to a wireless client device in a wireless communications network. The computer program comprises: a computer program code module for receiving at a proxy server via the wireless communications network a request for a media file using Hypertext Transfer Protocol (HTTP) from a wireless client device that supports progressive streaming; a computer program code module for obtaining by the proxy server headers for at least two media files using HTTP provided by one or more media servers different to the proxy server; a computer program code module for transmitting from the proxy server to the wireless client device via the wireless communications network using HTTP a header of a virtual media file derived from the headers of the at least two media files; a computer program code module for receiving by the proxy server from the wireless client device using HTTP a request for the virtual media file in response to the header of the virtual media file; and a computer program code module for transmitting from the proxy server to the wireless client device using HTTP the virtual media file comprising the obtained media files.

In accordance certain embodiments, there is provided a computer program product comprising a computer readable medium having recorded thereon a computer program for streaming media to a client device in a communications network. The computer program comprises: a computer program code module for sourcing by a proxy server using Real Time Streaming Protocol (RTSP) at least two separate media files from one or more media servers different to the proxy server in response to a client device request to the proxy server using RTSP for a virtual media file, duration information associated with the sourced media files being removed by the proxy server; and a computer program code module for streaming from the proxy server using RTSP the media files as the virtual media file to the client device via the communications network without transcoding or creating a new combined file, the virtual media file comprising the media files.

In accordance with certain embodiments, there is provided systems for streaming media to a wireless client device in a wireless communications network. For example, the system comprises: a wireless client device for communication using a wireless communications network, a plurality of media servers, and at least one proxy server. The wireless client device may be adapted for Hypertext Transfer Protocol (HTTP) progressive streaming. The media servers may be adapted for communications using at least one other communications network different to the wireless communications network. Each media server may store at least one media file. In certain aspects, the proxy server comprises: an interface adapted for communication using the wireless communications network; at least one other interface for communication with the media servers using the different communications network; a memory for storing data and a computer program for a processor; and a processor coupled to the wireless network interface, the at least one other interface, and the memory for executing the computer program. In certain aspects, the computer program comprises: a computer program code module for receiving at the proxy server via the wireless communications network a request for a media file using HTTP from the wireless client device that supports progressive streaming; a computer program code module for obtaining by the proxy server headers for at least two media files using HTTP provided by at least on of the media servers different to the proxy server; a computer program code module for transmitting from the proxy server to the wireless client device via the wireless communications network using HTTP a header of a virtual media file derived from the headers of the at least two media files; a computer program code module for receiving by the proxy server from the wireless client device using HTTP a request for the virtual media file in response to the header of the virtual media file; and a computer program code module for transmitting from the proxy server to the wireless client device using HTTP the virtual media file comprising the obtained media files.

In accordance with certain embodiments, there is provided systems for streaming media to a wireless client device in a wireless communications network. The system comprises: a client device for communication using a first communications network; a plurality of media servers; and a proxy server. The media servers are adapted for communications using at least one other communications network different to the first communications network. Each media server stores at least one media file. The proxy server comprises: an interface adapted for communication using the first communications network; at least one other interface for communication with the media servers using the different communications network; a memory for storing data and a computer program for a processor; and a processor coupled to the first network interface, the at least one other interface, and the memory for executing the computer program. The computer program comprises: a computer program code module for sourcing by a proxy server using Real Time Streaming Protocol (RTSP) at least two separate media files from one or more media servers different to the proxy server in response to a client device request to the proxy server using RTSP for a virtual media file, duration information associated with the sourced media files may be removed by the proxy server; and a computer program code module for streaming from the proxy server using RTSP the media files as the virtual media file to the client device via the communications network without transcoding or creating a new combined file, the virtual media file comprising the media files.

In certain aspects, the systems disclosed can deliver and/or stream the virtual media file, in real time, or substantially real time. In certain aspects, the systems disclosed are is able to insert ads and/or content dynamically on the fly and deliver and/or stream this information. In certain aspects, the systems can deliver and/or stream the virtual media file, or virtual media files to a plurality of users and are able to insert ads and/or content dynamically on the fly and deliver and/or stream this information in real time, or substantially real time.

Exemplary embodiments described herein may be more scalable than conventional methods and apparatuses for delivering multiple media files. For example, in exemplary embodiments, the increase in the amount of memory and/or processing power required to accommodate additional users may be reduced as compared to the increase required in conventional methods and apparatuses. For example, while maintaining substantially the same quality of service, exemplary methods and apparatuses described herein may require less than a 25% increase in processing power to accommodate twice as many requests as compared to conventional methods and apparatuses. In exemplary embodiments, the relative increase may be less than 20%, 15% 10%, 5%, 1%, 0.75%, 0.50%, or 0.25%. Similarly, while maintaining substantially the same quality of service, exemplary methods and apparatuses described herein may require less than a 25% increase in memory to accommodate twice as many requests as compared to conventional methods and apparatuses. In exemplary embodiments, the relative increase may be less than 20%, 15% 10%, 5%, 1%, 0.75%, 0.50%, or 0.25%.

Further, while maintaining substantially the same quality of service, exemplary methods and apparatuses described herein may be capable of delivering 100-1000 (e.g., 100, 200, 300, 400, 500, 600, 700, 800, 900, 1000) times as many requests as compared with conventional methods and apparatuses using substantially similar processing power and memory.

Exemplary embodiments may include an apparatus for delivering media to a wireless client wherein the apparatus is capable of transmitting a virtual media file obtained from two or more media files to the wireless device, and wherein the apparatus requires less than a 25% increase in at least one of the amount of memory or the amount of processing power required to accommodate additional users as compared to the increase required in conventional methods and apparatuses.

Exemplary embodiments may include an apparatus for delivering media to a wireless client wherein the apparatus is capable of transmitting a virtual media file obtained from two or more media files to the wireless device, and wherein the apparatus delivers 100 times as many requests as compared with conventional methods and apparatuses using substantially similar processing power and memory.

Exemplary embodiments described herein may also be perceived as seamless to users. For example, in exemplary embodiments, the delay from one media file to the next may not be perceivable to a user. In exemplary embodiments, this lack or perception may be accomplished by buffering the upcoming media file while the current media file is still playing. The amount of additional buffering may vary based on, for example, the available bandwidth.

Exemplary embodiments may include a method of streaming media to a wireless client comprising transmitting a virtual media file obtained from two or more media files to the wireless device, wherein the delay between the media files is not perceivable by a user.

Exemplary embodiments may also deliver the multiple media files in real-time or substantially real-time. Substantially real-time delivery may be possible in exemplary embodiments since creating a new media file may not be necessary. Accordingly, in exemplary embodiments, the multiple media files may be delivered without creating a new media file. In general, a one minute of video may take approximately three minutes to create into a new media file. In exemplary embodiments, the media files may be available to be delivered in less time than is required to create a new media file. For example, in exemplary embodiments, the media files may be delivered in less than 1 minute, 30 seconds, 15, seconds, 10 seconds, 5 second, 4 seconds, 3 seconds, 2 seconds, 1 second.

Exemplary embodiments may include a method of streaming media to a wireless client comprising transmitting a virtual media file obtained from two or more media files to the wireless device, wherein the virtual media file is available to be transmitted to the wireless device in less time than would be required to create a new media file from the two or more media files.

Other aspects, features, and advantages will become apparent from the following detailed description when taken in conjunction with the accompanying drawings, which are a part of this disclosure and which illustrate, by way of example, principles of the inventions disclosed.

### BRIEF DESCRIPTION OF THE DRAWINGS

The accompanying drawings facilitate an understanding of the various embodiments:

FIG. 1 is a block diagram illustrating a system for streaming media to a wireless client device adapted for HTTP progressive streaming in a wireless communications network in accordance with certain embodiments;

FIG. 2 is a data flow diagram illustrating communications between to the wireless client device and the proxy server of FIG. 1;

FIG. 3 is a flow diagram illustrating a method of streaming media to the wireless client device adapted for HTTP progressive streaming in the wireless communications network in accordance with certain embodiments;

FIG. 4 is a block diagram illustrating a system for streaming media to a client device in a communications network in accordance with certain embodiments;

FIG. 5 is a data flow diagram illustrating communications amongst the client device, the proxy server, and one or more media servers of FIG. 4; and

FIG. 6 is a flow diagram illustrating a method of streaming media to a client device in a communications network in accordance with the certain embodiments.

### DETAILED DESCRIPTION

The following description is provided in relation to several embodiments which may share common characteristics and features. It is to be understood that one or more features of any one embodiment may be combinable with one or more features of the other embodiments. In addition, any single feature or combination of features in any of the embodiments may constitute additional embodiments.

In this specification, the word “comprising” is to be understood in its “open” sense, that is, in the sense of “including”, and thus not limited to its “closed” sense, that is the sense of “consisting only of”. A corresponding meaning is to be attributed to the corresponding words “comprise”, “comprised” and “comprises” where they appear.

Methods, servers, systems, and computer program products are disclosed for streaming media to a wireless client device adapted for HTTP progressive streaming in a wireless communications network. Also, methods, servers, systems, and computer program products are disclosed for streaming media to a client device in a communications network. In the following description, numerous specific details, including particular wireless communications networks, other forms of communications networks, and the like are set forth. However, from this disclosure, it will be apparent that modifications and/or substitutions may be made without departing from the scope and spirit of the inventions. In other circumstances, specific details may be omitted so as not to obscure the inventions.

Video and/or audio can be delivered as media files a number of ways over the Internet Protocol (IP), using protocols such as Hypertext Transfer Protocol (HTTP) for progressive downloads or Real Time Streaming Protocol/Real-time Transport Protocol (RTSP/RTP) for streaming. Each method has its inherent strengths, and some software technologies only provide limited protocol support.

The disclosed embodiments provide methodologies of virtually combining media files without the need for, or the substantially need for, transcoding to create a new file, and delivery of the virtual file over HTTP and/or RTSP, which are video delivery protocols available on wireless devices. However, the present disclosure may be adapted and/or used other protocols.

An Apple™ iPhone™ for example supports HTTP progressive download to deliver media files, i.e. video and/or audio data, over the Internet Protocol Suite (TCP/IP) to the device. The downside of using HTTP is that a video must be a pre-rendered, complete media file before the HTTP connection is made between the client device (i.e. an Apple™ iPhone™) and a media server using HTTP. The requirement of a pre-rendered, complete media file limits the real-time decision making capabilities of server-side media (e.g. video) applications, such as advertising, without the use of a transcoding bank. Transcoders offer a limited scalable application when compared with a software solution.

Certain embodiments are directed to enabling real-time media (e.g., video and/or audio) application decisions that can be made using HTTP progressive streaming without the need for, or substantially without the need for, transcoders and/or pre-rendered complete media files. This enables real-time, or substantial real-time, media to be streamed to a client device via a wireless network using HTTP progressive streaming. Certain embodiments have one or more of the following aspects:
1) Two or more media files (e.g., video and/or audio files) can be combined and delivered over HTTP without transcoding or creating a new combined file;
2) MPEG1/2/4 are supported;
3) The media files can be stored on or sourced from different media (web) servers and the media servers may reside on different networks, which allows integration of the HTTP proxy without installing hardware and/or software on the media servers for streaming;
4) HTTP-enabled media player that supports MPEG1/2/4, including iPhone™, can have media files delivered to.

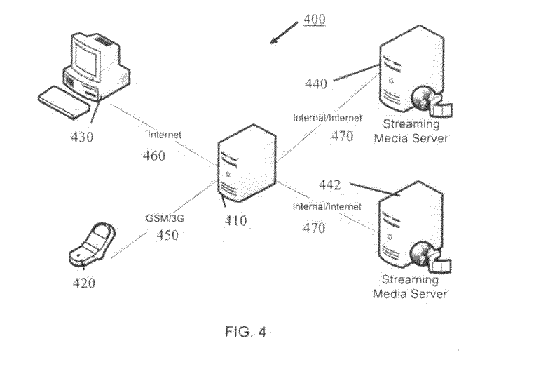

Streaming over HTTP can be implemented using the server architecture 100 depicted as an example in FIG. 1. The system 100 for streaming media to a wireless client device 120 in a wireless communications network 150 (e.g., a 3G mobile phone network) comprises the wireless client device (e.g., an Apple™ iPhone™) 120, a wireless communications network 150, an HTTP proxy server 110, and at least one media server 140, 142. The proxy server 110 is coupled to the media servers 140, 142 in the embodiment shown in FIG. 1 by an internal communications network or the Internet 170. The internal communications network may be a local area network (LAN), a wide area network (WAN), or an Intranet for example. While only two media servers are depicted in FIG. 1 (and FIG. 4), in fact more media servers may be coupled to the proxy server to provide media files, and hence only two media servers are depicted in FIGS. 1 and 4 for ease of illustration only. The proxy server 110 may be accessed by, or coupled to, another computer 130 by the Internet 160. The computer 130 represents any Internet-enabled device supporting HTTP and the video formats specified above can utilize the proxy. Each media server 140, 142 may be a web-, FTP-, or network-attached storage (NAS)-server, for example.

In accordance with certain embodiments, a media client application such as QuickTime™ (QT) or a client video application (e.g., VLC) on a client device or an iPhone™ 120 can view multiple media files (e.g., MPEG4 videos) using the proxy server 110 without downloading the media files each separately. These embodiments enable dynamic streaming to the client device 120 without the need to encode, or substantially encode, the multiple media files together as a single, complete media file. Instead, these embodiments provide a virtual media file, which while comprising several separate media files, appears to be a single media file to the client device 120 using HTTP progressive streaming. This enables other media content to be included in the stream of media files, e.g. an advertisement in a separate media file, downloaded through the proxy server 110 in real time, while accounting for targeting, frequency capping, additional advertisement related functionality or combinations thereof.

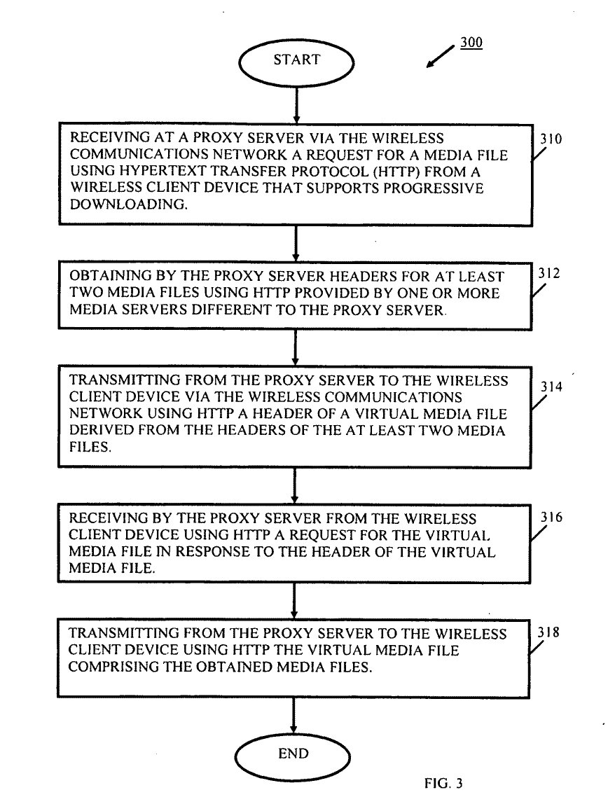

The proxy server 110 collects media header information from two or more media e.g., web) servers 140, 142 over a network/Internet and generates a new media header for the client device 120. The content may be located on a different media server 140, 142 than the proxy server 110. Once the media file is downloaded from the media server 140, 142, the downloaded media file may subsequently be cached on the proxy server 110, or another less remote computer such as computer 130 in FIG. 1. The proxy server 110 combines the media files dynamically without packet or quality loss. The proxy server 110 controls the content transmission according to the client's requests and can also control content fetching from the media servers 140, 142. This is done based on HTTP (RFC 2068) and MPEG4 (ISO 14496) standards. An example of these embodiments is illustrated with reference to FIG. 3.

FIG. 3 illustrates a method 300 of streaming media to the wireless client device 120 using the wireless communications network 150 (e.g., a 3G network). The client device 120 is preferably an Apple™ Iphone™, but can be a cellular telephone with a client application adapted for progressive streaming using HTTP. The wireless client device 120 supports progressive streaming in the wireless network 150. As discussed in this disclosure other downloading methods may be used. In step 310, the proxy server 110 receives via the wireless communications network 150 a request for a media file using Hypertext Transfer Protocol (HTTP) from the wireless client device 120, which supports progressive streaming. The media files may be audio files and/or video files. In step 312, the proxy server 110 obtains headers for at least two media files using HTTP. The media files are provided by one or more media servers 140, 142, which are different to the proxy server 110. The media servers 140, 142 are coupled to the proxy server 110 via one or more communications networks 170 different to the wireless communications network 150. Further, the communications network for the media server 140 may be different to the communications network for the media server 142. In step 314, the proxy server 110 transmits to the wireless client device 120 via the wireless communications network 150 using HTTP a header of a virtual media file derived from the headers of the at least two media files that were obtained by the proxy server 110. In step 316, the proxy server 110 receives from the wireless client device 120 using HTTP a request for the virtual media file in response to the header of the virtual media file. In step 316, the proxy server 110 transmits to the wireless client device 120 using HTTP the virtual media file comprising the obtained media files. Processing then terminates once the virtual media file completes transmission, as described in greater detail herein.

The proxy server 110 processes a client request, e.g. the client (Web/iPhone™) 120 sends a ‘GET’ HTTP request to the proxy server 110 as set out, for example, in Table 1.

TABLE 1

GET /test.m4v HTTP/1.1
Range: bytes=0-1023
Connection: close
User-Agent: Apple iPhone OS v2.0 CoreMedia v1.0.0.5A347
Accept: */*
Accept-Encoding: identity
Host: orion.netventures.com.au

The proxy server 110 gets (extracts) the URL (“/test.m4v HTTP/1.1”) from the received client request and parses the URL for getting the actual play list of media files from a database or another repository. This URL is for the “virtual” media file. The media file is “virtual” in that several media files are in fact streamed instead of a single complete media file. This play list includes the original source media file URLs from a media server(s) and storage type (local file/HTTP/FTP/Network File System). The playlist can contain advertising.

The proxy server 110 then collects the whole media file (e.g., video) information from the (backend) Web/FTP/NAS servers 140, 142. In particular, the proxy server 110 gets or obtains several media file headers from the relevant media server 140, 142 according to the play list. To illustrate this, the following four-step example [Steps A1-A4] is provided. [Step A1] The proxy server 110 sends a ‘GET’ request to the media (web) server 140 for a first media file (e.g. a video file) as set out in Table 2.

TABLE 2

GET /video1.m4v HTTP/1.1
Range: bytes=0-1023
Connection: Keep-Alive
Accept: */*

[Step A2] The media server 140 returns a ‘206’ response via the network 170 to the proxy server 110 if the requested media file exists at the media server 140, as shown in Table 3.

TABLE 3

HTTP/1.1 206 Partial Content
Fri, 29 Aug 2008 17:44:40 GMT
Accept-Ranges: bytes
Content-Length: 1024
Content-Range: bytes 0-1023/6563716
Connection: Keep-Alive
Content-Type: text/plain

[Step A3] The proxy server 110 reads the header of the media file from the response content from the ‘206’ response from the media server 140. If the content returned by the media server 140 does not have the entire header information of the media file, the proxy server 110 sends another request to the media server 140 to get the next block of header data in the manner of Step A1 above. For performance purposes, the proxy server 110 may only get one block size (defined in a configuration file) of meta data from the media server 140, 142 each time. Otherwise, the proxy server 110 saves/stores the whole header data (e.g., in cache) for later use and closes the connection with the media server 140.

[Step A4] The proxy server 110 continues processing to obtain the header information for the other remaining media files of the “virtual” media file. In particular, the proxy server 110 connects to the same or next media server for getting the header for the next media file in the playlist from the media server 140, 142. Processing continues at Step A1. In this manner, the entire playlist for the virtual media file is processed to obtain the header information for the virtual media file.

Once all the headers of the media files constituting the virtual media file are obtained, the proxy server 110 generates a new header for the virtual media file for the client device 120 or 130. For example, in the case of the media files being video, after getting all of the video headers in the play list, an MPEG4 module of the proxy server 110 generates a new video header from the video headers saved in the cache previously and includes a list that locates where the video data resides in each media server 140, 142.

Set out below is a description for merging MPEG4 video:
1. Calculate the entire video's (comprising all video files) duration and update the new duration in the new video header for the virtual video file. This information should be updated in the following headers: mvhd, tkhd, elst and mdhd.
2. Merge the sample to chunk header (‘stsc’) in each video file together according the video's sequence in the virtual video file. This allows the merged video to code the mapping from sample number to the correct chunk number in the new virtual video file.
3. Merge the sample size header (‘stsz’) in each video file together according the video's sequence. The stsz stores the count of the size of the samples in the new virtual video file.
4. Recount a chunk offset position in the new virtual video file for each video's chunk offset header (‘stco’) and save the new chunk offset to the new video ‘stco’ header. The new STCO is stored in the virtual media file header.
5. Recount the ‘moov’ header position in the new virtual video for each video ‘moov’ headers and save this information in cache for the later transmission usage along with the corresponding ‘mdat’ media data.

The proxy server 110 then sends the header of the virtual media file and media content to the client device 120 or 130. The proxy server 110 sends either a ‘200’ or ‘206’ response to the client device 120 or 130 using HTTP over TCP, followed by data in media files from the media servers 140, 142 according to the information described in generating the new header of the virtual media file. When a receiving buffer of the proxy server 110 has free space and the current video ‘mdat’ has been read completely, the proxy server 110 disconnect from the current media server 140 and then creates a new connection, for example with the media server 142, for getting the next video ‘mdat’. If all video files in the play list have been received by the proxy server 110, the proxy server 110 disconnects from the client device 120 after all data in a client-send-out buffer in the proxy server 110 is empty.

The streaming procedure for the client device 120, e.g., an iPhone, is described herein. The behavior of an iPhone™ in relation to the playback of video files behaves differently than other web browsers or media players. The iPhone™ 120 connects to the proxy server 110 three times to initiate the connection, in contrast with the single communication of traditional web based media players.

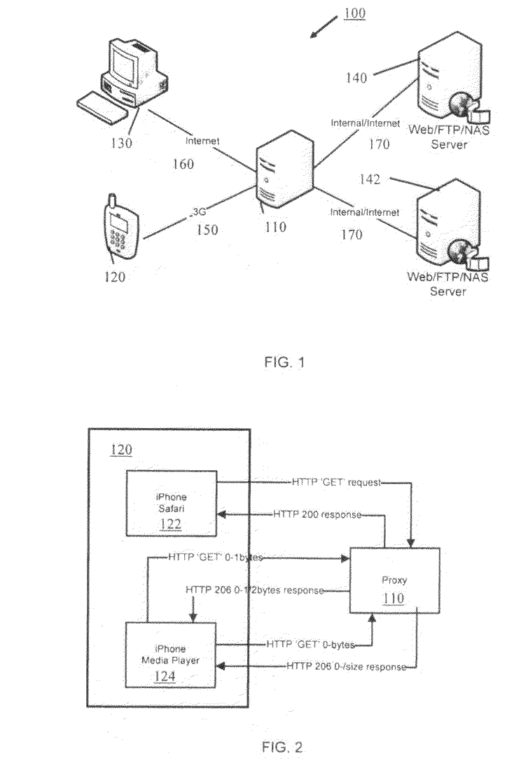

FIG. 2 is a data flow diagram illustrating communications between the iPhone™ 120 and the proxy server 110. The Safari™ web browser 122 of the iPhone™ 120 sends a request to the proxy server 110. The user inputs a URL (‘/test.m4v HTTP/1.1’) in the iPhone's Safari browser and clicks “go”. The client device 120 sends out an HTTP “GET” request to the proxy server 110, as shown in Table 4.

TABLE 4

GET /test.m4v HTTP/1.1
User-Agent: Mozilla/5.0 (iPhone; U;
CPU iPhone OS 2_0 like Mac OS X; en-us)
Apple WebKit/525.18.1
(KHTML, like Gecko) Version/3.1.1 Mobile/5A347 Safari/525.20
Accept:
text/xml,application/xml,application/xhtml+xml,text/html;q=0.9,
text/plain;q=0.8,
image/png,*/*;q=0.5
Accept-Language: en-us
Accept-Encoding: gzip, deflate
Connection: keep-alive
Host: orion.netventures.com.au

The proxy server 110 returns an HTTP “200” response to the client device 120, in particular to the Safari browser 122. The Safari web browser 122 receives the HTTP “200” response to ensure the requested “virtual” video exists and then the client device 120 closes the connection to the proxy server 110 through Safari and calls the iPhone's media player (Quicktime™ 124 to play the virtual video file, as shown in Table 5.

TABLE 5

HTTP/1.1 200 OK
Fri, 29 Aug 2008 17:44:37 GMT
Server: HTTPStreamingProxy/1.0
Accept-Ranges: bytes
Content-Length: 6563716
Connection: Keep-Alive
Keep-Alive: timeout=5, max=100
Content-Type: text/plain

The client device 120 then gets the size of the virtual video file. The iPhone™ 120 opens the media player application on the iPhone™ 120 and sends an HTTP GET 0-1 bytes request to the proxy server 110, which gets the first two bytes.

TABLE 6

GET/test.m4v HTTP/1.1
Range: bytes=0-1
Connection: close
User-Agent: Apple iPhone OS v2.0 CoreMedia v1.0.0.5A347
Accept: */*
Accept-Encoding: identity
Host: orion.netventures.com.au

In the HTTP 206 0-1/2 bytes response header from the proxy server 110, the iPhone media player 124 receives the whole video size, i.e. the size of the virtual video file, and then closes this connection, as shown in Table 7.

TABLE 7

HTTP/1.1 206 Partial Content
Fri, 29 Aug 2008 17:44:40 GMT
Server: HTTPStreamingProxy/1.0
Accept-Ranges: bytes
Content-Length: 2
Content-Range: bytes 0-1/6563716
Connection: close
Content-Type: text/plain

The media player 124 of the iPhone™ 120 gets the whole virtual video. In particular, the media player 124 creates a new connection to the proxy server 110 and sends an HTTP GET 0-bytes request to the proxy server 110 for obtaining the whole virtual video file, as shown in Table 8.

TABLE 8

GET /dgg.m4v HTTP/1.1
Range: bytes=0-6563715
Connection: close
User-Agent: Apple iPhone OS v2.0 CoreMedia v1.0.0.5A347
Accept: */*
Accept-Encoding: identity
Host: orion.netventures.com.au

The proxy server returns an HTTP ‘206’ 0-/size response (this response is the size of the partial content) and the video data follows with the HTTP header. When transmission is complete, the proxy server 110 may close the connection. In this manner, the separate video files constituting the virtual video file are streamed, as shown in Table 9.

TABLE 9

HTTP/1.1 206 Partial Content
Fri, 29 Aug 2008 17:44:40 GMT
Server: HTTPStreamingProxy/1.0
Accept-Ranges: bytes
Content-Length: 6563716
Content-Range: bytes 0-6563715/6563716
Connection: close
Content-Type: text/plain

The proxy server 110 enables a number of media files to be downloaded using HTTP progressive streaming to the client device 120 as a single “virtual” media file without transcoding or creating a new combined media file (in contrast to separate media files). Amongst other things, this allows content to be changed on the fly in the virtual media file, e.g. to provide advertising that is modifiable.

Real Time Streaming Protocol (RTSP) streaming video is an effective way to stream real-time video to mobile or online client devices. Real Time Streaming Protocol is built on the TCP/IP stack and uses a suite of protocols to deliver media (e.g., audio and/or video) with minimal delays, although packet loss can occur (as opposed to HTTP). Using Real-time Transport Protocol/Real-time Transport Control Protocol (RTP/RTCP) to deliver User Datagram Protocol (UDP) packets, certain embodiments enables additional functionality to control data rates to client applications to ensure a consistent stream with minimal packet loss or buffering.

An RTSP proxy server in accordance with certain embodiments provide at least one of the following functionalities to extend the RTSP protocol stack:

Two or more media files can be combined and delivered over RTSP without transcoding or creating a new combined file, which allows a media application to play a TV-like seamless playlist including multiple audio, video and advertising content;

Video types including MPEG1/2/4 are supported;

The media files can be stored on or sourced from different media servers residing on different networks, which allows integration of the RTSP proxy without installing hardware or software within the existing streaming network; and

Adaptive bandwidth detection can be created for the media streams, allowing the proxy server to detect the current network conditions of the client and adjust the bandwidth delivered to the client by selecting either a higher or lower bitrate encoded video stream. Adaptive bandwidth allows the best possible quality media stream to be delivered given the variability of network conditions without stopping or rebuffering the stream.

RTSP streaming can be implemented using the server architecture 400 depicted in FIG. 4. The system 400 for streaming media to a client device 420 in a communications network 450 (e.g., a GSM or 3G mobile phone network) comprises the client device 420, a communications network 450, an RTSP proxy server 410, and at least one media server 440, 442. The RTSP proxy server 410 is coupled to the media servers 440, 442 in the embodiment shown in FIG. 4 by an internal communications network or the Internet 470. The internal communications network may be a local area network (LAN), a wide area network (WAN), or an Intranet for example. Again, for ease of illustration, only two media servers 440, 442 are shown in FIG. 4, but more media servers may be employed. The proxy server 410 may be accessed by, or coupled to, another computer 430 by the Internet 460. The computer 430 demonstrates that any Internet-enabled device supporting RTSP and the video formats specified above can utilize the proxy server 410. Each media server 440, 442 may be a streaming media server, for example. The RTSP proxy server 410 implements a playlist function that can use the existing resources, i.e., media files, on the other streaming servers 440, 442. In one application, the RTSP proxy server 410 can dynamically insert advertisements (in a media file) into content (other media files) without generating a playlist file on the proxy server 410 in advance.

In a further aspect, if the streaming media server 440, 442 supports the functionality or the RTSP proxy server 410 can access the media file directly, the RTSP proxy server 410 also can implement adaptive bandwidth management to optimize the packet size delivery for the purpose of uninterrupted playout on the client device 420 or 430.

The RTSP proxy server 410 processes the client's RTSP commands and returns the media description, Session Description Protocol (SDP). The client device 420 gets the video and audio data (i.e., media files) from RTP transmissions and reports any packets lost, free buffer and additional information to the RTSP proxy server 410 via RTCP. The RTSP proxy server 410 or the streaming media server 440,442 can select a suitable bandwidth for the client and send this bit-rate media data to the client. This adaptive bandwidth management effectively reduces network congestion and improves playout at the client device 420, while minimizing buffering and maintaining a consistent viewing experience. These and other aspects are described in greater detail herein.

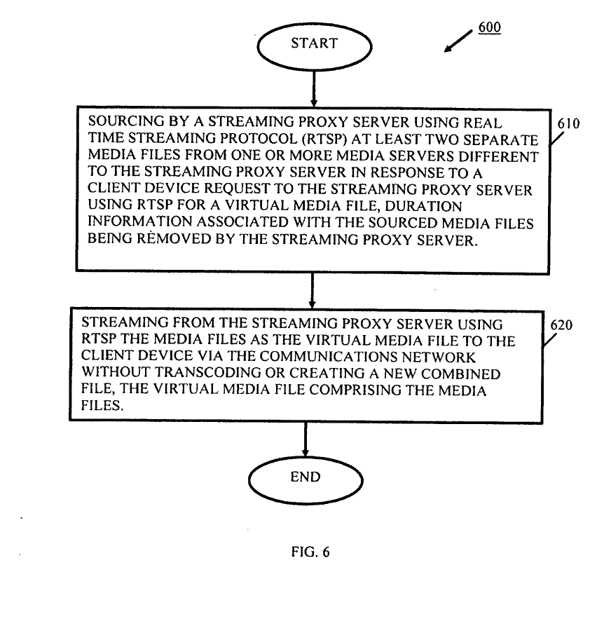

FIG. 6 illustrates a method 600 of streaming media to the client device 420 in the communications network 450, which may be a GSM or 3G mobile phone network, in accordance with certain embodiments. The client device may be a mobile phone or a computing device coupled by a wireless network to the proxy server using RTSP, or may be a computing device coupled by a communications network to the proxy server using RTSP. The proxy server 410 using Real Time Streaming Protocol (RTSP) sources at least two separate media files from the at least one media server 440, 442 different to the proxy server 410. This is done in response to a client device request to the proxy server using RTSP 410 for a virtual media file. The virtual media file comprises the media files. The sourced media files can comprise audio files and/or video files. The media files can be sourced from different web servers 440, 442 residing on different networks 470, and at least one of the sourced media files may comprise an advertisement, for example added to audio and/or video content of the virtual media file. Duration information associated with the sourced media files is removed by the RTSP proxy server 410. The RTSP proxy server 410 streams the media files as the virtual media file to the client device 420 via the communications network 450 without transcoding or creating a new combined file.

Optionally, the RTSP proxy server 410 detects the current network conditions of the client device 420 to which the media files are streamed and adjusts the bandwidth delivered to the client device 420 for streaming the media files by selecting either a higher or lower bitrate encoded video stream in response to the detected current network conditions. The data rates may be controlled using RTSP to the client device to ensure a consistent stream with minimal packet loss or buffering.

The sourcing step 610 involves several sub-steps. The RTSP proxy server 410 negotiates the request for a virtual media file between the client device 420 and the one or more media servers 440, 442; the duration information is removed from headers of the media files. Two UDP connections for RTP and RTCP are set up between the client device 420 and the RTSP proxy server 410, and two UDP connections for RTP and RTCP are set up between a first media server 440 and the RTSP proxy server 410. The client device 410 is provided two port numbers of the RTSP proxy server 410 for the UDP connections instead of two port numbers of the first media server 440. The streaming step 620 streams a first media file from the first media server 440 of the virtual media file to the client device 420 by the RTSP proxy server 410 using the UDP connections until the end of the first media file is reached.

The sourcing step 610 further comprises closing the two UDP connections for RTP and RTCP between the first media server 440 and the RTSP proxy server 410. Two UDP connections for RTP and RTCP are set up between a second media server 442 and the RTSP proxy server 410. The client device 420 is provided two port numbers of the proxy server for the UDP connections instead of two port numbers of the second media server 442. The streaming step 620 streams a second media file from the second media server 442 of the virtual media file to the client device 420 by the proxy server using RTSP using the UDP connections until the end of the second media file is reached. The two UDP connections for RTP and RTCP between the client device 420 and the RTSP proxy server 410 and the two UDP connections for RTP and RTCP between the second media server 442 and the RTSP proxy server 410 are then closed. This is for the case where the virtual media file comprises two media files. However, as will be well understood by those skilled in the art in the light of this disclosure, the virtual media file may be constituted of many more media files, e.g., 5 or 10 media files. The steps and substeps of FIG. 6 may be repeatedly performed several times to process the virtual media file before all the UDP connections are closed. This is described in greater detail herein by way of example.

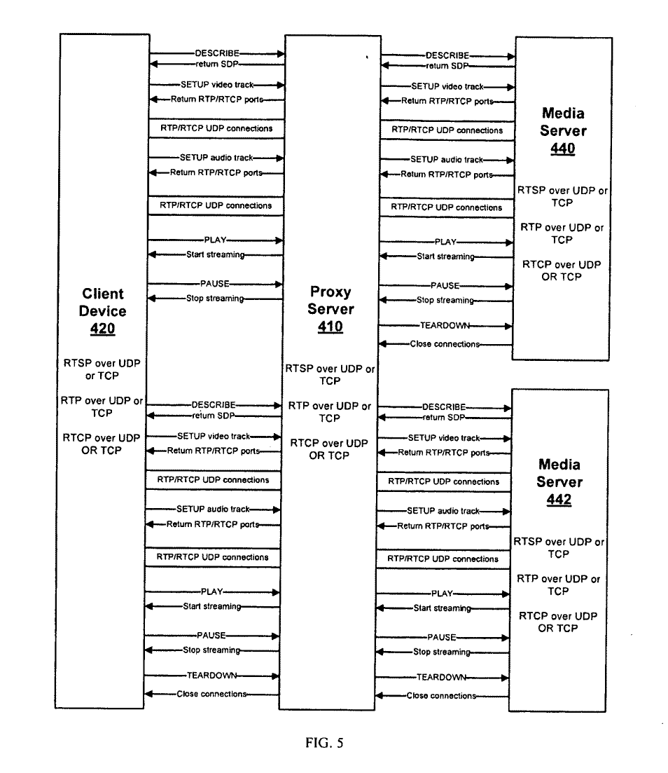

FIG. 5 is a block diagram showing communications and actions performed amongst the client device 420, the RTSP proxy server 410, and the media servers 440, 442 of FIG. 4. The communications and actions occur horizontally between the client device 420, the RTSP proxy server 410, and the media servers 440, 442 and vertically from the top downwards. FIG. 5 shows video track setup and audio track setup, but audio only is also possible. In FIG. 5, each of the client device 420, the proxy server 410 and the two depicted media servers 440, 442 are capable of implementing RTSP over UDP or TCP, RTP over UDP or TCP, and RTCP over UDP or TCP in certain embodiments. Other combinations are also contemplated.

The streaming procedure involves negotiations amongst the client device 420, the RTSP proxy server 410, and the media servers 440, 442 using RTSP. The client device 420 sends an RTSP ‘DESCRIBE’ request to the RTSP proxy server 410, which receives the request, as shown in FIG. 5 and described in Table 10.

TABLE 10

DESCRIBE rtsp://proxy/test.3gp RTSP/1.0
CSeq: 1
Accept: application/sdp
Bandwidth: 384000
Accept-Language: hr-HR
User-Agent: QuickTime/7.4.5 (qtver=7.4.5;os=Windows NT
5.1Service Pack 2)

The RTSP proxy server 410 parses the ‘DESCRIBE’ request from the client device 420 and obtains a play list using the URL (e.g., “rtsp://proxy/test.3gp”) parsed from the “DESCRIBE’ request. The URL received from the ‘DESCRIBE’ request is the location of the virtual playlist, which contains one or more media files that can be located on the streaming media servers, e.g. 440, 442.

The RTSP proxy server 410 connects via a communications network 470 to a streaming media server 440 (e.g., this might be a Darwin Streaming Server (DSS)) dependent on the play list (the playlist tells the proxy server the location and URL of the streaming servers to connect to), and sends an RTSP ‘DSCRIBE’ request to that media server 440 for a media file from the playlist forming part of the virtual media file to be sent to the client device 420 ultimately. The proxy server 410 sends the request and waits for a response from the media server 440 as shown in FIG. 5 and described in Table 11.

TABLE 11

DESCRIBE rtsp://dss/v1.3gp RTSP/1.0
CSeq: 1
Accept: application/sdp
Bandwidth: 384000
Accept-Language: hr-HR
User-Agent: QuickTime/7.4.5 (qtver=7.4.5;os=Windows NT
5.1Service Pack 2)

The RTSP proxy server 410 receives and processes a ‘200’ or ‘400’ type response from the media server 440 and returns the result to the client device 420. The processing by the RTSP proxy server 410 involves creating the same type response for the client device 420 but with the duration information from the media server 440 content removed, as described in Table 12. In FIG. 5, a media description file SDP is the playlist file for the streaming server. That is, the proxy server 410 removes the duration information from the response to be sent to the client device 420.

TABLE 12

RTSP/1.0 200 OK
Server: DSS/5.5.5 (Build/489.16; Platform/Win32; Release/Darwin;
state/beta; )
Cseq: 1
Last-Modified: Fri, 13 Jun 2008 00:16:46 GMT
Cache-Control: must-revalidate
Content-length: 611
Date: Tue, 08 Jul 2008 05:15:19 GMT
Expires: Tue, 08 Jul 2008 05:15:19 GMT
Content-Type: application/sdp
x-Accept-Retransmit: our-retransmit
x-Accept-Dynamic-Rate: 1
Content-Base: rtsp://192.168.10.98/ING.3gp/

Table 13 illustrates a sample SDP content.

TABLE 13
v=0
o=StreamingServer 3425590278 1213316206000 IN IP4 192.168.10.98
s=\test.3gp
u=http:///
e=admin@
c=IN IP4 0.0.0.0
b=AS:79
t=0 0
a=control:*
a=x-copyright: MP4/3GP File hinted with GPAC 0.4.4 (C)2000-2005 -
http://gpac.sourceforge.net
a=range:npt=0-30.16667
m=video 0 RTP/AVP 96
b=AS:68
a=rtpmap:96 MP4V-ES/90000
a=control:trackID=65536
a=fmtp:96 profile-level-id=1;
config=000001b001000001b58913000001000000012000-
c4958800650584121463000001b24c61766335312e34302e34
a=framesize:96 176-144
m=audio 0 RTP/AVP 97
b=AS:11
a=rtpmap:97 AMR/8000/1
a=control:trackID=65537
a=fmtp:97 octet-align

The RTSP proxy server 410 removes the line containing ‘a=range:npe’ in Table 13. The “a=range” attribute defines the total time range of the stored session or an individual media. This attribute is removed as the attribute is created dynamically in the virtual file.

Referring to FIG. 5, the client device 420 gets video and audio track information from the SDP content from the media server 440 modified by the RTSP proxy server 410. The SDP file is the video and audio information; SDP is a description file like a meta header. Two pairs of UDP connections (RTP and RTCP) are created for data transmission. One pair of UDP connections is between the client device 420 and the RTSP proxy server 410 and the other pair of UDP connections is between the RTSP proxy server 410 and the streaming media server 440.

The client device 420 sets up or creates a video track to the proxy server 410. The setup is handled by RTSP and is outlined below in Table 15 using the information from the SDP file. This information is indicated in the SDP of Table 13, with the relevant portions extracted in Table 14.

TABLE 14

a=rtpmap:96 MP4V-ES/90000
a=control:trackID=65536

Table 15 shows an RTSP ‘SETUP’ request sent from the client device 420 to the RTSP proxy server 410 to set up a pair of UDP connections between the client device 420 and the RTSP proxy server 410. The foregoing describes the initial connection between the phone and the proxy.

TABLE 15

SETUP rtsp://proxy/test.3gp/trackID=65536 RTSP/1.0
CSeq: 2
Transport: RTP/AVP;unicast;client_port=6974-6975
x-retransmit: our-retransmit
x-dynamic-rate: 1
x-transport-options: late-tolerance=1.400000
User-Agent: QuickTime/7.4.5 (qtver=7.4.5;os=Windows NT
5.1Service Pack 2)
Accept-Language: hr-HR

In Table 15, the client device 420 provides its client ports as client_port=6974-6975.

The proxy server 410 in turn creates two UDP connections for RTP and RTCP with the media server 440, listens for data from the media server 440, and forwards data from the media server 440 to the client device 420. To do so, the RTSP proxy server 410 sends an RTSP ‘SETUP’ request to the media server 440. Table 16 shows the RTSP ‘SETUP’ request sent to the media server 440 by the RTSP proxy server 410.

TABLE 16

SETUP rtsp://dss/v1.3gp/trackID=65536 RTSP/1.0
CSeq: 2
Transport: RTP/AVP;unicast;client_port=10001-10002
x-retransmit: our-retransmit
x-dynamic-rate: 1
x-transport-options: late-tolerance=1.400000
User-Agent: QuickTime/7.4.5 (qtver=7.4.5;os=Windows NT
5.1Service Pack 2)
Accept-Language: hr-HR

As shown in Table 16, client ports provided to the media server 440 (e.g., client_port=10001-10002) in the SETUP request are those of the RTSP proxy server 410, not the client device 420 (client_port=6974-6975). Thus, the RTSP proxy server 410 changes the “client_port” to its ports, which are sent to the The streaming media server 440 creates two ports for the RTSP proxy server 410 and returns the port numbers (server_port=6970-6971) in its response to the RTSP proxy server 410, as shown in Table 17.

TABLE 17
Server: DSS/5.5.5 (Build/489.16; Platform/Win32; Release/Darwin;
state/beta; )
Cseq: 2
Last-Modified: Fri, 13 Jun 2008 00:16:46 GMT
Cache-Control: must-revalidate
Session: 27754078682099
Date: Tue, 08 Jul 2008 05:15:19 GMT
Expires: Tue, 08 Jul 2008 05:15:19 GMT
Transport: RTP/AVP;unicast;source=192.168.10.98;client_port=10001-
10002;server_port=6970-6971;ssrc=00007A45
x-Transport-Options: late-tolerance=1.400000
x-Retransmit: our-retransmit
x-Dynamic-Rate: 1;rtt=15

In its response shown in Table 17, the media server 440 indicates the client ports (client_port=10001-10002) are those of the proxy server 410.

The RTSP proxy server 410 creates two ports for the client device 420 and returns the port numbers (server_port=10001-10002) in its response to the client device 420, as shown in Table 18, instead of the port numbers (server_port=6970-6971) of the media server 440.

TABLE 18
Server: DSS/5.5.5 (Build/489.16; Platform/Win32; Release/Darwin;
state/beta; )
Cseq: 2
Last-Modified: Fri, 13 Jun 2008 00:16:46 GMT
Cache-Control: must-revalidate
Session: 27754078682099
Date: Tue, 08 Jul 2008 05:15:19 GMT
Expires: Tue, 08 Jul 2008 05:15:19 GMT
Transport: RTP/AVP;unicast;source=192.168.10.98;client_port=6974-
6975;server_port=10001-10002;ssrc=00007A45
x-Transport-Options: late-tolerance=1.400000
x-Retransmit: our-retransmit
x-Dynamic-Rate: 1;rtt=15

In its response shown in Table 18, the RTSP proxy server 410 indicates the client ports (client_port=6974-6975) are those of the client device 420.

In a similar fashion as above for the video track, the client creates two UDP connections to the RTSP proxy server 410 for an audio track, and the RTSP proxy server 410 also creates two UDP connections to the media server 440, as set forth in Tables 19-22.

Again, the client device 420 sends an RTSP ‘SETUP’ request to the RTSP proxy server 410, as stated in Table 19.

TABLE 19

SETUP rtsp://proxy/test.3gp/trackID=65537 RTSP/1.0
CSeq: 3
Transport: RTP/AVP;unicast;client_port=6972-6973
x-retransmit: our-retransmit
x-dynamic-rate: 1
x-transport-options: late-tolerance=1.400000
Session: 27754078682099
User-Agent: QuickTime/7.4.5 (qtver=7.4.5;os=Windows NT
5.1Service Pack 2)
Accept-Language: hr-HR

The proxy server 410 similarly creates two UDP connections for RTP and RTCP with the media server 440 using an RTSP ‘SETUP’ request, as set out in Table 20.

TABLE 20

SETUP rtsp://dss/v1.3gp/trackID=65537 RTSP/1.0
CSeq: 3
Transport: RTP/AVP;unicast;client_port=10002-10003
x-retransmit: our-retransmit
x-dynamic-rate: 1
x-transport-options: late-tolerance=1.400000
Session: 27754078682099
User-Agent: QuickTime/7.4.5 (qtver=7.4.5;os=Windows
NT 5.1Service Pack 2)
Accept-Language: hr-HR

The streaming media server 440 creates two ports for the RTSP proxy server 410 and returns the port numbers (server_port=6970-6971) in its response to the RTSP proxy server 410, as shown in Table 21. The 200 OK is issued in the responses to the requests, not the requests.

TABLE 21
RTSP/1.0 200 OK
Server: DSS/5.5.5 (Build/489.16; Platform/Win32; Release/Darwin;
state/beta; )
Cseq: 3
Session: 27754078682099
Last-Modified: Fri, 13 Jun 2008 00:16:46 GMT
Cache-Control: must-revalidate
Date: Tue, 08 Jul 2008 05:15:19 GMT
Expires: Tue, 08 Jul 2008 05:15:19 GMT
Transport: RTP/AVP;unicast;source=192.168.10.98;client_port=10002-
10003;server_port=6970-6971;ssrc=000033BF
x-Transport-Options: late-tolerance=1.400000
x-Retransmit: our-retransmit
x-Dynamic-Rate:1

The RTSP proxy server 410 creates two ports for the client device 420 and returns the port numbers (server_port=10002-10003) in its response to the client device 420, as shown in Table 22, instead of the port numbers (server_port=6970-6971) of the media server 440.

TABLE 22
RTSP/1.0 200 OK
Server: DSS/5.5.5 (Build/489.16; Platform/Win32; Release/Darwin;
state/beta; )
Cseq: 3
Session: 27754078682099
Last-Modified: Fri, 13 Jun 2008 00:16:46 GMT
Cache-Control: must-revalidate
Date: Tue, 08 Jul 2008 05:15:19 GMT
Expires: Tue, 08 Jul 2008 05:15:19 GMT
Transport: RTP/AVP;unicast;source=192.168.10.98;client_port=6972-
6973;server_port=10002-10003;ssrc=000033BF
x-Transport-Options: late-tolerance=1.400000
x-Retransmit: our-retransmit
x-Dynamic-Rate:1

In the foregoing manner, pairs of UDP connections are formed between the client device 420 and the RTSP proxy server 410 on one hand and between the RTSP proxy server 410 and the media server 440 on the other hand. This is done to both video and audio tracks in this example. The client and server ports are substituted in the response to the client with the correct ports for the RTSP proxy server 410, so that the client device 420 connects to the correct ports of the RTSP proxy server 410, which differ from the server ports used between RTSP proxy server 410 and the streaming media server 440. Referring to FIG. 5, after the foregoing steps are performed, RTP/RTCP UDP connections are established for video and audio tracks between the client device 420 and the proxy server 410 and between the proxy server 410 and the media server 440.

After UDP connection pairs are setup or created, the client device 420 sends an RTSP ‘PLAY’ command to the RTSP proxy server 410 start streaming of the media file comprising video and audio content in this example, as set out in Table 23. The file ‘virtual.3gp’ is the virtual media file in the following example.

TABLE 23

PLAY rtsp://proxy/virtual.3gp RTSP/1.0
CSeq: 4
x-prebuffer: maxtime=2.000000
x-transport-options: late-tolerance=10
Session: 27754078682099
User-Agent: QuickTime/7.4.5 (qtver=7.4.5;os=Windows NT
5.1Service Pack 2)

In turn, the RTSP proxy server 410 sends an RTSP ‘PLAY’ command to the media streaming server 440, as set out in Table 24.

TABLE 24

PLAY rtsp://dss/v1.3gp RTSP/1.0
CSeq: 4
x-prebuffer: maxtime=2.000000
x-transport-options: late-tolerance=10
Session: 27754078682099
User-Agent: QuickTime/7.4.5 (qtver=7.4.5;os=Windows NT
5.1Service Pack 2)

In this example, as shown in Table 24, the media file v1.3gp is the media file sourced from the media server 440 that is part of the virtual media file, virtual.3gp.

In response to the PLAY command, the media server 440 returns a response to the RTSP proxy server 410, as set out in Table 25.

TABLE 25

RTSP/1.0 200 OK
Server: DSS/5.5.5 (Build/489.16; Platform/Win32; Release/Darwin;
state/beta; )
Cseq: 4
Session: 27754078682099
Range: npt=0.00000-30.16667
RTP-Info:
url=rtsp://192.168.10.98/ING.3gp/trackID=65536;seq=8079;rtptime=
13307,url=r
tsp://dss/v1.3gp/trackID=65537;seq=30715;rtptime=32005

The server 440 returns the information to get the video data (e.g. video data constituting an advertisement or content).

The RTSP proxy server 410 removes the “Range” entry (Range: npt=0.00000-30.16667) in the RTSP header and replaces the server address and the filename (rtsp://dss/v1.3gp changed to rtsp://proxy/virtual.3gp) before sending the response to the client device 420, as set forth in Table 26.

TABLE 26

RTSP/1.0 200 OK
Server: DSS/5.5.5 (Build/489.16; Platform/Win32; Release/Darwin;
state/beta; )
Cseq: 4
Session: 27754078682099
RTP-Info:
url=rtsp://192.168.10.98/ING.3gp/trackID=65536;seq=8079;rtptime=
13307,url=r
tsp://proxy/virtual.3gp/trackID=65537;seq=30715;rtptime=32005

The current connection between the RTSP proxy server 410 and the streaming media server 440 is closed once the media file sourced from that media server 440 is downloaded. Thus, after the sourced media file is played completely by the client device 420, the RTSP proxy server 410 must change to the next streaming media server 442 and get the next media file streaming that is part of the virtual media file. This is depicted in FIG. 5, where the RTSP proxy server 410 sends an RTSP ‘TEARDOWN’ command to the to current media server 440 and then closes the UPD connections (including RTSP and two pairs of RTP/RTCP connections) between the media server 440 and the proxy server 410.

The RTSP proxy server 410 then connects to the next media server 442. The RTSP proxy server 410 finds in the playlist the next media file. If the end of the playlist is reached, the RTSP proxy server 410 waits for the client device 420 to close connections, described hereinafter in more detail. If connecting to another media server 442, the RTSP proxy server 410 performs the steps described above:

a) Client, Proxy, and Media Server Negotiations using RTSP;

b) Setting Up RTP/RTCP UDP Connection; and

c) Streaming of Media File from Streaming Media Server.

The new UDP connection pair between the RTSP proxy server 410 and the media server 442 still use the old UDP connections between the RTSP proxy server 410 and the client device 420. This makes new video and audio data can be continually transmitted to client.

When the media files from streaming sources are played for the virtual media file, the client device 420 sends an RTSP ‘PAUSE’ command to the proxy server 410 to stop the streaming at the end of the virtual media file, as described in Table 27.

TABLE 27

PAUSE rtsp://proxy/virtual.3gp RTSP/1.0
CSeq: 6
Session: 27754078682099
User-Agent: QuickTime/7.4.5 (qtver=7.4.5;os=Windows NT
5.1Service Pack 2)

The RTSP proxy server 410 also sends an RTSP ‘PAUSE’ request to the streaming media server 442, as set out in Table 28.

TABLE 28

PAUSE rtsp://dss/v5.3gp RTSP/1.0
CSeq: 6
Session: 27754078682099
User-Agent: QuickTime/7.4.5 (qtver=7.4.5;os=Windows NT
5.1Service Pack 2)

The streaming media server 442 sends a response to the RTSP proxy server 410, as stated in Table 29

TABLE 29

RTSP/1.0 200 OK
Server: DSS/5.5.5 (Build/489.16; Platform/Win32; Release/Darwin;
state/beta; )
Cseq: 6
Session: 27754078682099

In turn, the RTSP proxy server 410 sends the same response to the client device 420.

TABLE 30

RTSP/1.0 200 OK
Server: DSS/5.5.5 (Build/489.16; Platform/Win32; Release/Darwin;
state/beta; )
Cseq: 6
Session: 27754078682099

To close the UDP connections, the client device 420 sends an RTSP ‘TEARDOWN’ request to the RTSP proxy server 410, as set out in Table 31.

TABLE 31

TEARDOWN rtsp://prxoy/virtual.3gp RTSP/1.0
CSeq: 7
Session: 27754078682099
User-Agent: QuickTime/7.4.5 (qtver=7.4.5;os=Windows NT
5.1Service Pack 2)

In turn, the RTSP proxy server 410 also sends an RTSP ‘TEARDOWN’ request to the streaming media server 442, as stated in Table 32.

TABLE 32

TEARDOWN rtsp://DSS/v5.3gp RTSP/1.0
CSeq: 7
Session: 27754078682099
User-Agent: QuickTime/7.4.5 (qtver=7.4.5;os=Windows NT
5.1Service Pack 2)

The streaming media server 442 then returns a response to the RTSP proxy server 410, as set out in Table 33.

TABLE 33

RTSP/1.0 200 OK
Server: DSS/5.5.5 (Build/489.16; Platform/Win32; Release/Darwin;
state/beta; )
Cseq: 7
Session: 27754078682099
Connection: Close

Also, the RTSP proxy server 410 returns the same “200” response result that the connection is closed to the client device 420, as stated in Table 34.

TABLE 34

RTSP/1.0 200 OK
Server: DSS/5.5.5 (Build/489.16; Platform/Win32; Release/Darwin;
state/beta; )
Cseq: 7
Session: 27754078682099
Connection: Close

The methods in accordance with the disclosed embodiments may be implemented using a general purpose computer system, for example as the proxy server running software. The methods may be implemented as software, such as one or more application programs executable within the computer system. In particular, the steps of the method are effected by instructions in the software that are carried out within the computer system. The instructions may be formed as one or more code modules, each for performing one or more particular tasks. The software may also be divided into two separate parts, in which a first part and the corresponding code modules performs the method and a second part and the corresponding code modules manage a user interface between the first part and the user. The software may be stored in a computer readable medium, including the storage devices described hereinafter, for example. The software is loaded into the computer system from the computer readable medium, and then executed by the computer system. A computer readable medium having such software or computer program recorded on the computer readable medium is a computer program product. The use of the computer program product in the computer system preferably effects an advantageous apparatus.

The computer system 100 comprises a computer module 101, input devices such as a keyboard 102, a mouse pointer device 103, and output devices including a display device 114. An external Modulator-Demodulator (Modem) transceiver device may be used by the computer module for communicating to and from a communications network. The network may be a wide-area network (WAN), such as the Internet or a private WAN. The computer may be connected to the network using a high capacity (e.g., cable) connection, and the modem may be a broadband modem. A wireless modem may also be used for wireless connection to the network.

The computer module typically includes at least one processor unit, and a memory unit for example formed from semiconductor random access memory (RAM) and read only memory (ROM). The computer module also includes a number of input/output (I/O) interfaces including an audio-video interface that couples to the video display and loudspeakers, an I/O interface for the keyboard and mouse and an interface for the external modem. The computer module 101 also has a local network interface that permits coupling of the computer system to a local computer network, known as a Local Area Network (LAN). The local network may also couple to the wide-area network via a connection, which would typically include a so-called “firewall” device or similar functionality. The interface may be formed by an Ethernet™ circuit card, a wireless Bluetooth™ or an IEEE 802.11 wireless arrangement.

Storage devices are provided and typically include a hard disk drive (HDD). Other devices such as a floppy disk drive and a magnetic tape drive (not illustrated) may also be used. An optical disk drive is typically provided to act as a non-volatile source of data. Portable memory devices, such optical disks (e.g., CD-ROM, DVD), USB-RAM, and floppy disks for example may then be used as appropriate sources of data to the system.

Examples of computers on which the described arrangements can be practised include IBM-PC's and compatibles, Sun Sparcstations, Apple™ Mac™ or alike computer systems evolved therefrom.

Typically, the application programs discussed above are resident on the hard disk drive and read and controlled in execution by the processor. Intermediate storage of such programs and any data fetched from the networks may be accomplished using the semiconductor memory, possibly in concert with the hard disk drive. In some instances, the application programs may be supplied to the user encoded on one or more CD-ROM and read via the corresponding drive, or alternatively may be read by the user from the networks. Still further, the software can also be loaded into the computer system from other tangible computer readable media. Computer readable media refers to any storage medium that participates in providing instructions and/or data to the computer system 100 for execution and/or processing. Examples of such media include floppy disks, magnetic tape, CD-ROM, a hard disk drive, a ROM or integrated circuit, a magneto-optical disk, or a computer readable card such as a PCMCIA card and the like, whether or not such devices are internal or external of the computer module. Examples of computer readable transmission media that may also participate in the provision of instructions and/or data include radio or infra-red transmission channels as well as a network connection to another computer or networked device, and the Internet or Intranets including e-mail transmissions and information recorded on Websites and the like.

The second part of the application programs and the corresponding code modules mentioned above may be executed to implement one or more graphical user interfaces (GUIs) to be rendered or otherwise represented upon the display. Through manipulation of the keyboard and the mouse, a user of the computer system and the application may manipulate the interface to provide controlling commands and/or input to the applications associated with the GUI(s).

The methods to be described may also be implemented, at least in part, in dedicated hardware such as one or more integrated circuits performing the functions or sub functions to be described. Such dedicated hardware may include dedicated processors, digital signal processors, or one or more microprocessors and associated memories.

A number of methods, servers, systems, and computer program products for streaming media to a wireless client device adapted for HTTP progressive streaming in a wireless communications network have been disclosed with reference to embodiments of the invention. Also, methods, servers, systems, and computer program products have been disclosed for streaming media to a client device in a communications network. The embodiments disclosed are applicable to the computer and data processing industries, amongst others.

The foregoing describes only some embodiments of the inventions, and modifications and/or changes can be made thereto without departing from the scope and spirit of the disclosed embodiments, the embodiments being illustrative and not restrictive. Furthermore, the inventions have described in connection with what are presently considered to be the most practical and preferred embodiments, it is to be understood that the invention is not to be limited to the disclosed embodiments, but on the contrary, is intended to cover various modifications and equivalent arrangements included within the spirit and scope of the inventions. Also, the various embodiments described above may be implemented in conjunction with other embodiments, e.g., aspects of one embodiment may be combined with aspects of another embodiment to realize yet other embodiments. Further, each independent feature or component of any given assembly may constitute an additional embodiment.

What is claimed is:

1. A method of delivering time-based media to a wireless client device in a wireless communications network, said method comprising the steps of:
A) receiving at a proxy server via said wireless communications network a request for a media file using Hypertext Transfer Protocol (HTTP) from a wireless client device that supports progressive streaming;
B) obtaining by said proxy server headers for at least two media files using HTTP provided by one or more media servers different to said proxy server;
C) transmitting from said proxy server to said wireless client device via said wireless communications network using HTTP a header of a virtual media file derived from said headers of said at least two media files;
D) receiving by said proxy server from said wireless client device using HTTP a request for said virtual media file in response to said header of said virtual media file; and
E) transmitting from said proxy server to said wireless client device using HTTP said virtual media file comprising said obtained media files.

2. The method according to claim 1, wherein said wireless client device only supports progressive streaming in said wireless network.

3. The method according to claim 1, wherein said one or more media servers are coupled to said proxy server via another communications network different to said wireless communications network.

4. The method according to claim 1, wherein said obtained media files comprise audio files and/or video files.

5. The method according to claim 1, wherein at least one of said obtained media files comprises an advertisement.

6. The method according to claim 1, wherein said wireless client device comprises an Apple™ Iphone™.

7. The method according to claim 1, wherein said wireless client device comprises a cellular telephone with a client application adapted for progressive streaming using HTTP.

8. The method for delivering media to a wireless client according to any of the above claims, wherein the apparatus requires less than a 25% increase in at least one of the amount of memory or the amount of processing power required to accommodate additional users as compared to the increase required in conventional methods and apparatuses.

9. The method for delivering media to a wireless client according to any of the above claims, wherein the apparatus delivers 100 times as many requests as compared with conventional methods using substantially similar processing power and memory.

10. The method for delivering media to a wireless client according to any of the above claims, wherein the delay between the media files is not perceivable by a user.

11. The method for delivering media to a wireless client according to any of the above claims, wherein the virtual media file is available to be transmitted to the wireless device in less time than would be required to create a new media file from the two or more media files.

12. A method of media file delivery to a client device in a communications network, said method comprising the steps of:
sourcing by a proxy server using Real Time Streaming Protocol (RTSP) at least two separate media files from one or more media servers in response to a client device request to said proxy server for a virtual media file, modifying duration information associated with said sourced media files at said proxy server; and
transmitting from said proxy server using RTSP said media files as said virtual media file to said client device via said communications network without transcoding or creating a new combined file, said virtual media file comprising said media files.

13. The method according to claim 12, further comprising the steps of:
detecting the current network conditions of said client device to which said media files are delivered; and
adjusting the bandwidth delivered to said client device for delivering said media files by selecting either a higher or lower bitrate encoded video delivery in response to said detected current network conditions.

14. The method according to claim 12, further comprising the step of controlling data rates using RTSP to said client device to ensure a consistent delivery with minimal packet loss or buffering.

15. The method according to claim 12, wherein said media files are sourced from different web servers residing on different networks.

16. The method according to claim 12, wherein said sourced media files comprise audio files and/or video files.

17. The method according to claim 12, wherein at least one of said sourced media files comprises an advertisement.

18. The method according to claim 12, wherein:
said sourcing step comprises:
negotiating by said proxy server using RTSP said request for a virtual media file between said client device and said one or more media servers, wherein said duration information is removed from headers of said media files;
setting up two UDP connections for RTP and RTCP between said client device and said proxy server using RTSP and two UDP connections for RTP and RTCP between a first media server and said proxy server using RTSP, said client device being provided two port numbers of said proxy server for said UDP connections instead of two port numbers of said first media server; and
said delivery step delivers a first media file from said first media server of said virtual media file to said client device by said proxy server using RTSP using said UDP connections until the end of the first media file is reached.

19. The method according to claim 18, wherein:
said sourcing step comprises:
closing said two UDP connections for RTP and RTCP between said first media server and said proxy server using RTSP;
setting up two UDP connections for RTP and RTCP between a second media server and said proxy server using RTSP, said client device being provided two port numbers of said proxy server for said UDP connections instead of two port numbers of said second media server; and
said delivery step delivers a second media file from said second media server of said virtual media file to said client device by said proxy server using RTSP using said UDP connections until the end of the second media file is reached.

20. The method according to claim 19, further comprising the step of closing said two UDP connections for RTP and RTCP between said client device and said proxy server using RTSP and said two UDP connections for RTP and RTCP between said second media server and said proxy server using RTSP.

21. The method according to claim 8, wherein said client device is a mobile phone or a computing device coupled by a wireless network to said proxy server using RTSP.

22. The method according to claim 12, wherein said client device is a computing device coupled by a communications network to said proxy server using RTSP.

23. A proxy server for delivering media to a wireless client device in a wireless communications network, said server comprising:
means for receiving at a proxy server via said wireless communications network a request for a media file using Hypertext Transfer Protocol (HTTP) from a wireless client device that supports progressive streaming;
means for obtaining by said proxy server headers for at least two media files using HTTP provided by one or more media servers different to said proxy server;
means for transmitting from said proxy server to said wireless client device via said wireless communications network using HTTP a header of a virtual media file derived from said headers of said at least two media files;
means for receiving by said proxy server from said wireless client device using HTTP a request for said virtual media file in response to said header of said virtual media file; and
means for transmitting from said proxy server to said wireless client device using HTTP said virtual media file comprising said obtained media files.

24. A proxy server for delivering time-based media to a client device in a communications network, said server comprising:
means for sourcing by a proxy server using Real Time Streaming Protocol (RTSP) at least two separate media files from one or more media servers different to said proxy server in response to a client device request to said proxy server using RTSP for a virtual media file, duration information associated with said sourced media files being removed by said proxy server; and
means for delivering from said proxy server using RTSP said media files as said virtual media file to said client device via said communications network without transcoding or creating a new combined file, said virtual media file comprising said media files.

25. A computer program product comprising a computer readable medium having recorded thereon a computer program for delivering time-based media to a client device in a communications network, said computer program comprising:
computer program code means for receiving at a proxy server via said communications network a request for a media file using a transfer protocol from a client device;
computer program code means for obtaining by said proxy server headers for at least two media files using a transfer protocol provided by one or more media servers different to said proxy server;
computer program code means for transmitting from said proxy server to said client device via said communications network using a transfer protocol a header of a virtual media file derived from said headers of said at least two media files;
computer program code means for receiving by said proxy server from said client device using a transfer protocol a request for said virtual media file in response to said header of said virtual media file; and
computer program code means for transmitting from said proxy server to said client device using a transfer protocol said virtual media file comprising said obtained media files.

26. A computer program product comprising a computer readable medium having recorded thereon a computer program for delivering media to a client device in a communications network, said computer program comprising:
computer program code means for sourcing by a proxy server using Real Time Streaming Protocol (RTSP) at least two separate media files from one or more media servers different to said proxy server in response to a client device request to said proxy server using RTSP for a virtual media file, duration information associated with said sourced media files being removed by said proxy server; and
computer program code means for streaming from said proxy server using RTSP said media files as said virtual media file to said client device via said communications network without transcoding or creating a new combined file, said virtual media file comprising said media files.

27. A system for delivering media to a wireless client device in a wireless communications network, said system comprising:
a wireless client device for communication using a wireless communications network, said wireless client device adapted for Hypertext Transfer Protocol (HTTP) progressive streaming;
a plurality of media servers adapted for communications using at least one other communications network different to said wireless communications network, each media server storing at least one media file; and
a proxy server comprising:
an interface adapted for communication using said wireless communications network;
at least one other interface for communication with said media servers using said different communications network;
a memory for storing data and a computer program for a processor;
a processor coupled to said wireless network interface, said at least one other interface, and said memory for executing said computer program, said computer program comprising:
a computer program code module for receiving at said proxy server via said wireless communications network a request for a media file using HTTP from said wireless client device that supports progressive streaming;
a computer program code module for obtaining by said proxy server headers for at least two media files using HTTP provided by at least on of said media servers different to said proxy server;
a computer program code module for transmitting from said proxy server to said wireless client device via said wireless communications network using HTTP a header of a virtual media file derived from said headers of said at least two media files;
a computer program code module for receiving by said proxy server from said wireless client device using HTTP a request for said virtual media file in response to said header of said virtual media file; and
a computer program code module for transmitting from said proxy server to said wireless client device using HTTP said virtual media file comprising said obtained media files.

28. A system for streaming media to a wireless client device in a wireless communications network, said system comprising:
a client device for communication using a first communications network;
a plurality of media servers adapted for communications using at least one other communications network different to said first communications network, each media server storing at least one media file; and
a proxy server comprising:
an interface adapted for communication using said first communications network;
at least one other interface for communication with said media servers using said different communications network;
a memory for storing data and a computer program for a processor;
a processor coupled to said first network interface, said at least one other interface, and said memory for executing said computer program, said computer program comprising:
a computer program code module for sourcing by a proxy server using Real Time Streaming Protocol (RTSP) at least two separate media files from one or more media servers different to said proxy server in response to a client device request to said proxy server using RTSP for a virtual media file, duration information associated with said sourced media files being removed by said proxy server; and
a computer program code module for streaming from said proxy server using RTSP said media files as said virtual media file to said client device via said communications network without transcoding or creating a new combined file, said virtual media file comprising said media files.

29. An apparatus for delivering media to a wireless client comprising:
a proxy server configured to transmit a virtual media file obtained from two or more media files to the wireless device,
wherein the proxy server delivers 100 times as many requests as compared with conventional methods using substantially similar processing power and memory;
wherein the delay between the media files is not perceivable by a user; and
wherein the virtual media file is available to be transmitted to the wireless device in less time than would be required to create a new media file from the two or more media files.

30. The methods of any of the preceding claims wherein the methods can deliver the virtual media file, in real time, or substantially real time.

31. The methods of any of the preceding claims wherein the methods are able to insert ads and/or content dynamically on the fly and deliver this information.

32. The methods of any of the preceding claims wherein the methods deliver the virtual media file, or virtual media files to a plurality of users and are able to insert ads and/or content dynamically on the fly and deliver this information in real time, or substantially real time.
